(19) United States
(12) Patent Application Publication
(10) Pub. No.: US 2006/0179882 A1
(43) Pub. Date: Aug. 17, 2006

(54) Polarizing glass and manufacturing method of polarized glass

(75) Inventors: Masahiro Ichimura, Niigata (JP); Yuichi Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/350,540

(22) Filed: Feb. 9, 2006

Related U.S. Application Data
(60) Provisional application No. 60/652,163, filed on Feb. 11, 2005.

(51) Int. Cl. C03B 23/037; C03B 27/012

(52) U.S. Cl. 65/32.3; 65/33.1; 65/102

(57) ABSTRACT

The method for producing the polarizing glasses which have elongated metal particles oriented uniformly and dispersed, includes a glass base material preparing process in which the metal halide particles are precipitated in the strip of the glass base material; a elongating process in which the glass base material is heated by heaters set around the glass base material, and elongated by a drawing means set outside of the heaters along the longitudinal direction of the glass base material; and a reducing process in which the metal halide particles included in the elongated glass which is elongated in the elongating process are reduced. In the elongating process, the powers of the heaters are controlled so that the glass base material shrinks the outlines of the elongated part of the glass base material tilting by the tilt angle between 5 degrees and 20 degrees to the longitudinal direction of the glass base material.

### CROSS REFERENCE TO RELATED APPLICATION

The present application claims priority from a U.S. Provisional Application No. 60/652,163 filed on Feb. 11, 2005, the contents of which are incorporated herein by reference.

### BACKGROUND OF THE INVENTION

1. Field of the Invention

This invention relates to polarizing glasses and a producing method of the same.

2. Related Art

Polarizing glasses are used for polarized wave dependent optical isolators in near infrared region, which is used in the optical communication. The optical isolator comprises a magnetic garnet film sandwiched between two polarizing glasses. The optical isolator allows light from laser diode (LD) to transmit therethrough, and prevents light from returning to the LD.

The polarizing glasses include elongated metal particles which orient in a uniform direction and disperse inside thereof. The dispersing light absorption coefficients of elongated metal particles are very different in between the major axial direction and the minor axial direction, which is called dichroic property. The extinction ratio of polarizing glass is dependent on the dichromatic property of the elongated metal particle. In general, the major axis is called polarizing axis. The optical isolator can cut off light very efficiently, if two polarizing axes of the polarizing glasses are tilted each other by 45 degrees with the high accuracy. The greater the angle defined by the polarizing axes of the two polarizing glasses deviates from 45 degrees, the more the cut-off performance of the optical isolator lowers. The lower cut-off performance makes oscillation of LD unstable, because the optical isolator cannot cut off the light returning to the LD completely.

In order to make the angle between the polarizing axes of the two polarizing glasses 45 degrees accurately, each direction of polarizing axes is required to be uniform over the whole of each polarizing glass. It is needed to control the variation of the directions of elongated metal particles in the polarizing glasses.

Conventionally, the polarizing glasses are made by elongating strips of glass base material, or glass preforms to prepare elongated glasses, and then polishing the elongated glasses to a certain thickness. The thickness of the elongated glasses after being polished is typically 0.5 mm or less. The processing technique with high accuracy is required. This is the reason for the difficulty in reducing the cost of producing the polarizing glasses.

There is a method to reduce the variation of the polarizing axis and the producing cost of the polarizing glasses, which is to elongate the glass preforms with a certain temperature distribution control as disclosed, for example, in Japanese Patent Application Publication No. 2004-224660.

According to the JP 2004-224660, the method can have a certain effect on reducing the variation of the polarizing axis. The method can also decrease the deviation from flatness of the elongated glass which is made by elongating the glass preform. This allows reducing the cost of polishing the glass, resulting in reducing the total cost of the polarizing glasses. The deviation from flatness is defined by the Japanese Industrial Standards as the interspace between two parallel planes.

Another method to reduce the roughness of the surfaces of the elongated glasses is known, which is to elongate the glass preforms after being polished the both surfaces thereof as disclosed, for example, in U.S. Pat. No. 3,105,491.

Yet another method is known, which is adjusting the temperature of the elongated part which is heated by a heater, and the tensile stress applied to the elongated glass. This allows controlling the tensile stress applied along the elongating direction evenly over the width of the elongated glass to reduce the variation of the polarizing axis as disclosed, for example, in U.S. Application Publication No. 2004/0172974.

Such prior art method of elongating the glass preform with a certain temperature distribution control has a problem that it cannot sufficiently reduce the variation of the direction of the polarizing axis. The method of polishing the glass preform before elongating also has a problem that if the glass preform is warped during being elongated, the deviation from flatness of the elongated glass increases. No method to reduce the variation of the in-plane extinction ratio of the polarizing glasses has been known. The method which reduces the variation of the direction of the polarizing axis adequately has been also unknown.

### SUMMARY OF THE INVENTION

To solve the above problems, according to the first embodiment of the present invention, the producing method of polarizing glasses having elongated metal particles oriented in a uniform direction and dispersed therein comprises; a preparing process to prepare a strip of glass base material containing metal halide particles precipitated therein; an elongating process to elongate the glass base material and the metal halide particles while heating the glass base material with heaters put around the glass base material and drawing the glass base material to the longitudinal direction thereof with a drawing means set outside of the heaters along the longitudinal direction of the glass base material; and a reducing process to reduce the metal halide particles included in the elongated glass and elongated in the elongating process. In the elongating process, the powers of the heaters are controlled so that the glass base material shrinks with the outlines of the elongated part thereof tilting against the longitudinal direction thereof by from 5 degrees to 20 degrees.

According to the present producing method, the metal halide particles can be elongated by applying a stress evenly over the width of the glass base material, and can be oriented uniformly along the longitudinal direction of the glass base material. This allows the polarizing glasses to have the small in-plane variation of the extinction ratio and the polarizing axis oriented uniformly. When the glass base material is elongated, the difference of the viscosity is small enough in the width of the elongated part thereof, resulting that the polarizing glass products with the small deviation from flatness can be produced.

According to the present producing method, the heaters may comprise a main heater which faces at the elongated part of the strip of the glass base material and heats near the center of the width of the elongated part, and side heaters which heat the elongated part of the strip from the sides of the elongated part of the strip. The powers of the heaters may be controlled in the elongating process so that the temperature of the center of the width of the strip of the glass base material is equal to or lower than the temperature of the outer parts of the width. In that case, it is preferred that the powers of the side heaters are bigger than that of the main heater. Therefore, the temperature distribution over the width of the elongated part of the glass base material can be controlled easily, and the tensile stress along the longitudinal direction can be applied evenly over the width of the elongated part.

In the present producing method, the powers of the heaters may be controlled in the elongating process so that the temperature of the glass base material is no less than the straining point temperature and no more than the softening point temperature. Such control of the heaters allows the glass base material and the metal halide particles to be elongated easily.

In the present producing method, the drawing means used in the elongating process may apply the stress of between 200 kg/cm² and 500 kg/cm² evenly over the width of the strip. This allows the polarizing glasses to have the high extinction ratio to wavelengths in near infrared region.

According to the second embodiment of the present invention, polarizing glasses includes the elongated metal particles oriented in a uniform direction and dispersed, which are produced by the method which comprises; a preparing process to prepare a strip of glass base material containing metal halide particles precipitated therein; an elongating process to elongate the glass base material and the metal halide particles while heating the glass base material with heaters put around the glass base material and drawing the glass base material to the longitudinal direction thereof with a drawing means set outside of the heaters along the longitudinal direction of the glass base material; and a reducing process to reduce the metal halide particles included in the elongated glass and elongated in the elongating process. In the elongating process, the powers of the heaters are controlled so that the glass base material shrinks with the outlines of the elongated part thereof tilting against the longitudinal direction thereof by from 5 degrees to 20 degrees. This can produce the polarizing glasses in which the variation of tilt angle of the polarizing axis of the elongated glass against the elongated direction of the elongated glass is 0.5 degrees or less.

The above description of the present invention doesn't cite all the features of the present invention. The sub-combinations of these features may also be inventions.

### BRIEF DESCRIPTION OF THE DRAWINGS

FIG. 1 shows the structure of the elongating apparatus 100.

FIG. 2 is a conceptual drawing showing the metal halide particles 22 are elongating.

FIG. 3 is a chart showing a distribution of the tilt angle of the polarizing axis over the width of the elongated glass.

FIG. 4 is a chart showing a distribution of the tilt angle of the polarizing axis over the width of the elongated glass.

FIG. 5 is a chart showing a distribution of the tilt angle of the polarizing axis over the width of the elongated glass.

FIG. 6 is a chart showing a distribution of the tilt angle of the polarizing axis over the width of the elongated glass.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

The producing method of the present embodiment comprises at least a glass base material preparing process, an elongating process, and a reducing process. In the glass base material preparing process, a glass base material having metal halide particles precipitated therein is prepared. In the elongating process, the glass base material and the metal halide particles are heated with heaters, and elongated. In the reducing process, the metal halide particles which are included in the elongated glass elongated in the elongating process are reduced so that the elongated metal halide particles are oriented in a uniform direction and dispersed, which makes the polarizing glass.

In the glass base material preparing process, the glass base material may be produced by the method disclosed in the U.S. Pat. No. 4,479,819. The glass base material preparing process includes a glass melting process and a heat treating process. In the glass melting process, the glass containing metals and halides of the metals is melted. In the present embodiment, silver is used as the metal, and at least one silver halide selected from chlorides, bromides, and iodides is used. The composition of the glass can be selected from the compositions disclosed on the U.S. Pat. No. 4,190,451. Cupper may also be used as the metal, and cupper chloride may be used as the cupper halide.

In the heat treating process, the melted glass is treated with heat so that the metal halide particles precipitate. Metal halide particles such as AgCl, AgBr, and Agl are precipitated. The particle sizes, or diameters of the particles, are between about 20 nm and 500 nm. The heat treating process also includes a nucleating process, and a nucleus growing process in which crystal nuclei grow. The nucleating speed and the particle growing speed depend on the processing temperature. The nuclei form by being processed at least in one hour at the temperature within the range higher than the glass transition point temperature and lower than the softening point temperature, at which the nucleating speed is relatively fast. On the other hand, the nuclei grow by being processed at least in two hours, at the temperature within the range higher than the softening point temperature and lower than 70 degrees over the softening point temperature, at which the particle growing speed is relatively fast. In this heat treating process, metal halides such as AgCl and AgBr are precipitated. The diameters of the precipitated particles are from 20 nm to 200 nm, preferably 100 nm or less.

The diameters and the amount of the precipitated particles can be known indirectly by using haze values. In the heat treating process, the haze value is controlled to be 2% to 35%. Higher haze value indicates that the diameters of the precipitated particles are large. If the diameters of the precipitated particles are large, the metal halide particles can be elongated with a smaller stress in a desired aspect ratio in the elongating process. Therefore, the glass base material and the elongated glass can be prevented from breaking. Larger precipitated particles, however, tend to cause a smaller extinction ratio, and to increase insertion losses. Therefore, the haze value should be controlled within the range from 2% to 35%, preferably from 5% to 20%. After the heat treating process, the glass is formed into a strip of a glass preform. The glass preform is shaped, for example, 70 mm in width, 215 mm in length, and 2 mm in thickness. If cupper is used as the metal, and CuCl as a cupper halide, the same heat treating process can be applied.

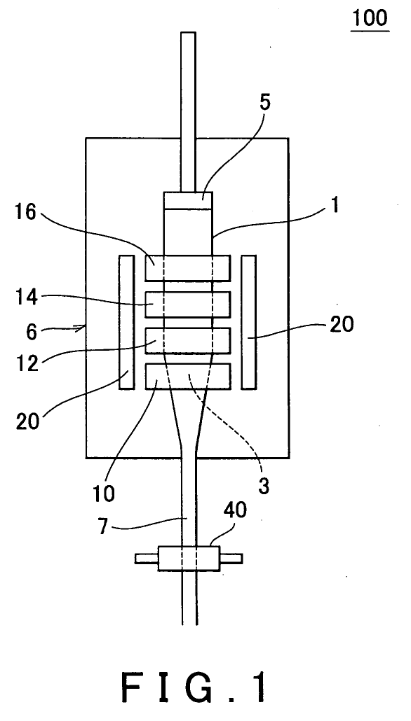

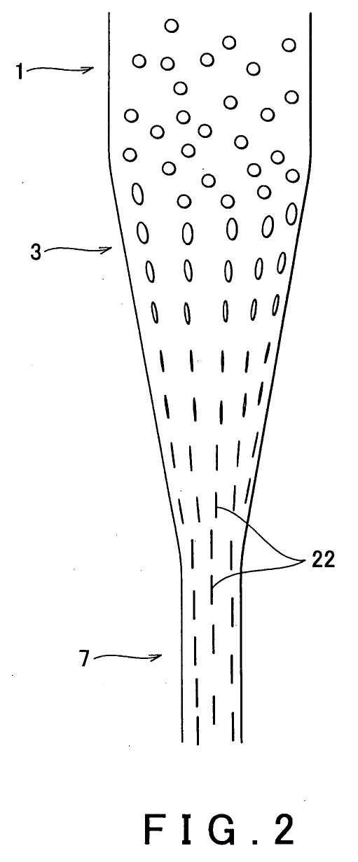

FIG. 1 shows the structure of an elongating apparatus used in the elongating process of the present embodiment. FIG. 2 is a conceptual drawing which shows that the metal halide particles 22 are being elongated. The elongating apparatus 100 comprises an electric furnace 6, a glass supporting means 5 set inside the electric furnace 6, various heaters 10, 12, 14, 16, and 20 also set inside the electric furnace 6, and a drawing means 40 set downward from the various heaters described above along the longitudinal direction of the preform 1.

In the elongating process, the glass preform 1 is fixed by the glass supporting means 5, heated by the various heaters set around the glass preform 1, and drawn by the drawing means 40 along the longitudinal direction of the glass preform 1. In the present embodiment, the strip of the glass preform 1 is fixed the one end by the glass supporting means 5 set over the glass preform 1, and drawn down the other end by the drawing means 40 set below the heaters. Referring to the positional relationships shown in FIG. 1, the present embodiment is explained below. However, the elongating direction of the glass preform is not necessarily downward. The glass preform 1 may be fixed the lower end with the glass supporting means 5, and drawn the upper end by the drawing means 40 set over the heaters.

The glass preform 1 is heated by the various heaters 10, 12, 14, 16, and 20 set around the glass preform 1. The heaters include a main heater 10 which heats near the center of the width of the elongated part 3 from the front of the strip of the elongated part 3 where the glass preform 1 shrinks along the width direction, side heaters 20 which heats the side surfaces of the elongated part 3 from the sides of the strip of the elongated part 3, and sub-heaters 12, 14 and 16 set above the main heater 10 at certain intervals.

The main heater 10 and the sub-heaters 12, 14, and 16 are slightly wider than the glass preform 1. The power of each heater 10, 12, 14, 16, or 20 is controlled independently. The glass preform 1 can, therefore, be heated with the appropriate temperature distribution to be elongated. The glass preform 1 is heated with the temperature distribution so that the glass preform 1 can be elongated well, resulting that the metal halide particles can also be elongated well. The sub-heaters 12, 14, and 16 heat the upper part of the elongated part 3 gradually.

The glass preform 1 is heated to the temperature at which the viscosity of the glass preform 1 is between 1×10⁹ poise and 1×10¹⁴ poise, and then applied the stress of between 200 kg/cm² and 500 kg/cm² to be elongated the metal halide particles in the aspect ratio of between 2:1 and 100:1 to make the elongated glass 7. It is preferred that the viscosity of the glass preform 1 is controlled between 1×10¹⁰ poise and 1×10¹² poise. The stress is applied evenly across the width of the glass preform 1. The vector component of the stress applied to the glass preform 1 is approximately parallel to the elongated direction, or the longitudinal direction of the glass preform 1. It is preferred that the stress is from 300 kg/cm² to 450 kg/cm².

In the above elongating process, the powers of the various heaters 10, 12, 14, 16, and 20 are controlled so that the temperature of the glass preform 1 is no less than the glass transition point temperature and no more than the softening point temperature. The powers of the main heater 10 and side heaters 20 are also controlled so that the temperature of the middle of the width of the strip of the glass preform 1 is equal to or less than the temperature of the outer parts of the strip of the glass preform 1. In the present embodiment, the power of each heater is controlled so that the glass preform shrinks with the outlines of the elongated part 3, where the glass preform 1 is elongated, tilting against the longitudinal direction of the glass preform 1 by a given tilt angle. For example, the powers of the main heater 10, side heaters 20, and sub-heaters 12, 14, and 16 are controlled so that the glass preform shrinks with the outlines of the elongated part 3 tilting against the longitudinal direction of the glass preform 1 by between 5 degrees and 20 degrees. It is preferred that the powers of the side heaters 20 are larger than that of the main heater 10. If the tilt angles of the outlines of the elongated part 3 meet the above condition, the both sides of the width of the elongated part 3 are heated with higher temperature than the middle part thereof. Therefore if the elongated part 3 is cooled off gradually below the main heater 10 and the side heaters 20, the difference of the viscosities of the both sides cooling faster and the middle part cooling more slowly is small when the glass and the metal halide particles 22 are elongated. When the cooling process proceeds to the temperature which is equal to or less than the glass transition temperature, the glass stops being elongated, and the metal halide particles 22 also stop being elongated. Note that the ratio of the metal halide particles 22 to the glass preform 1 in size is expressed bigger than the actual one in FIG. 2.

According to the above elongating process, the metal halide particles 22 can be elongated evenly over the width of the glass preform 1, and the metal halide particles 22 can be oriented uniformly along the longitudinal direction of the glass preform 1. The difference of the viscosities across the width of the elongated part is small when the glass base material is elongated, which allows producing the polarizing glass having small deviation from flatness after the elongating process. In the elongating process, the temperature distribution over the width of the glass preform may be even.

The residual distortion made in the elongated glass 7 during the elongating process is removed now. The elongated glass 7 is annealed at the temperature which is no less than the glass straining point temperature and no more than the glass transition temperature. For example, if the annealing process is done at the higher temperature than the glass transition point temperature, such as the annealing point temperature, the elongated metal halide particles 22 may be re-globurized, which isn't preferred.

In the reducing process, a part or the whole of the metal halide particles 22 is reduced to metal particles in the atmosphere of hydrogen gas. Hydrogen can permeate deeply into the inside of the glass at higher reducing temperature, which allows the reducing process to be shorter. Similarly to the above annealing process, if the reducing temperature is higher than the glass transition point temperature, the metal halide particles may be re-globurized. The reducing temperature, however, isn't high enough, it takes a longer time for the reducing process to cost more. Therefore, the reducing process should be done at the temperature between the straining temperature and the glass transition temperature. When the reducing process finishes, the polarizing glass is completed.

According to the present embodiments, the polarizing glass which has the small in-plane variation of the extinction ratio, and the polarizing axis oriented in the uniform direction is provided. For example, the oriented direction of the elongated metal halide particles, or the polarizing axis tilts by 0.5 degrees or less against the elongated direction of the elongated glass generated from the glass base material, in at least an area of 11 mm square in the elongated glass. The variation of the extinction ratio of the polarizing glass made with the present embodiment is 10 dB or less in an area of 11 mm square. The thickness variation of the polarizing glass according to the present embodiment is 0.03 mm or less along the width of the strip. The extinction ratio of the polarizing glass according to the present embodiment is 50 dB or more in the wavelength range of at least 300 nm.

### Embodiment 1

The glass batch which includes, in weight percent, Li2O: 1.8 wt %, Na2O: 5.5 wt %, K2O: 5.7 wt %, B2O3: 18.2 wt %, Al2O3: 6.2 wt %, SiO2: 56.3 wt %, Ag: 0.24 wt %, Cl: 0.16 wt %, Br: 0.16 wt %, CuO: 0.01 wt %, Zr O2: 5.0 wt %, TiO2: 2.3 wt %, was pre-melted in a platinum melting pot at the temperature of about 1350 degrees. The pre-melted glass was broken into cullets which are as big as candies, then full-melted in the platinum melting pot at the temperature of about 1450 degrees, poured into a graphite mold to be cast, and annealed in an annealing furnace. Brought out from the annealing furnace, the glass base material was prepared.

The glass base material is nucleated in one hour at the temperature of 610 degrees, and treated with heat on the condition of particle generation for 4 hours at the temperature of 740 degrees. The silver halide particles, such as AgCl and Ag Br were precipitated in the average diameter of 60 nm. The haze of a 2 mm thick part of the glass was about 10%. The heat treated glass base material was shaped into the experimental glass preform of 70 mm in width, 250 mm in length, and 2 mm in thickness to be prepared for the elongating process.

In the elongating process, the glass preform was heated so that the viscosity of the glass preform was between about 1×10¹⁰ and 1×10¹¹ poise, and applied the tensile stress of 350 kg/cm² evenly over the width of the glass preform to be elongated, which resulted the elongated glass. Meanwhile, the powers of the main heater 10, side heaters 20, and sub-heaters 12, 14, and 16 were controlled so that the glass preform shrunk with the outlines of the elongated part of the glass preform tilting along the longitudinal direction of the elongated glass by 11 degrees. The glass preformed was fed at the speed of 2.0 mm/min, and the elongated glass was taken in at the speed of 35 mm/min.

The resulted aspect ratio of the elongated silver halide particles was 20:1, and the resulted elongated glass was 17 mm in width. The thicknesses of the middle part and the both sides of the elongated glass were 0.495 mm and 0.499 mm respectively, and the thickness variation was 0.01 mm or less.

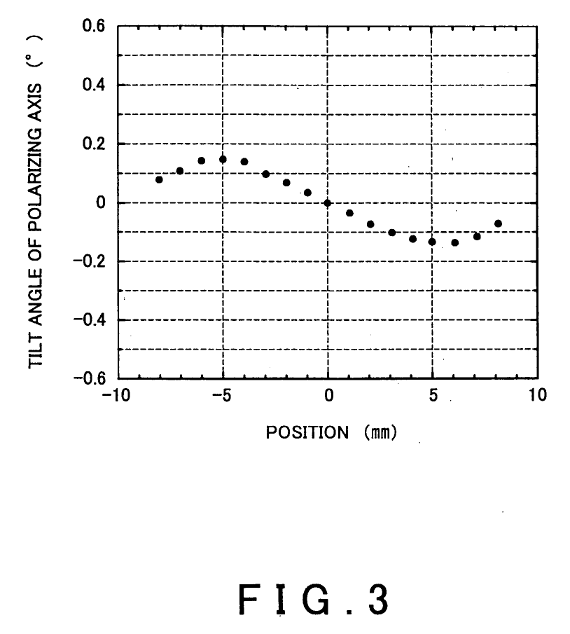

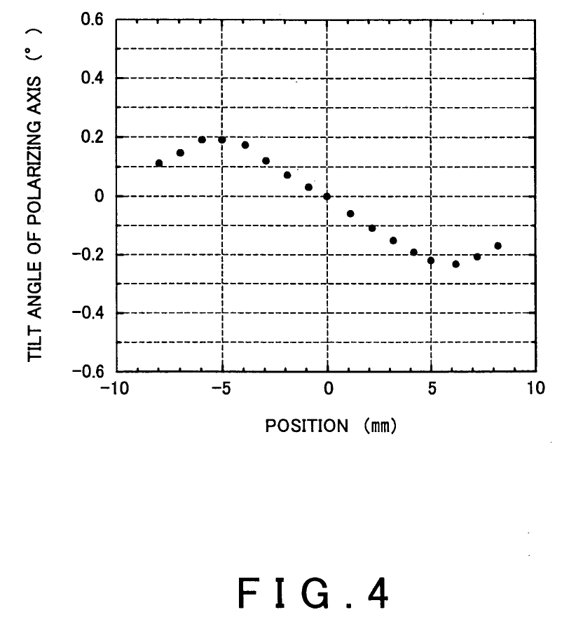

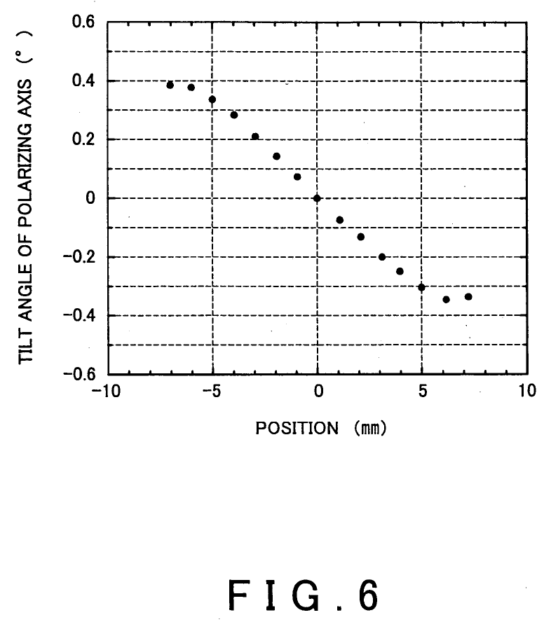

The elongated glass was put in the atmosphere of hydrogen gas and reduced in 4 hours at the temperature of 470 degrees. After the reducing process, the extinction ratio of the glass was measured 55 plus or minus 2 dB in the area of 16 mm square. The tilt angles of the polarizing axis which were measured in the circle with radius 8 mm around the center of the 17 mm width of the elongated glass were no more than 0.4 degrees, or plus or minus 0.20 degrees, in all directions shown in FIG. 3. The horizontal axis of the chart indicates the position on the width of the elongated glass, and value of zero means the center point of the width. The vertical axis of the chart indicates the tilt angle of the polarizing axis against the reference polarizing axis whose tilt angle is zero at the center point of the width of the elongated glass. The description above can be applied to FIGS. 4-6.

### Embodiment 2

The glass base material of the embodiment 1 was treated with heat similarly to the embodiment 1 to be prepared an experimental glass preform with the same shape. The glass preform was applied the stress by a taking-in means approximately parallel to the longitudinal direction of the glass preform to be prepare the elongated glass. In the present embodiment, the powers of the main heater 10, side heaters 20, and sub-heaters 12, 14, and 16 were controlled so that the glass preform shrunk with the outlines of the elongated part of the glass preform tilting against the longitudinal direction thereof by the tilt angle of about 14 degrees. The tensile stress applied to the glass preform, and the speeds of taking in the glass preform were the same as the embodiment 1.

The width of the resulted elongated glass was 17 mm, the thicknesses of the middle part and the both sides were 0.475 mm and 0.486 mm respectively, the thickness variation was no more than 0.02 mm. The extinction ratio of the resulted elongated glass was 55 plus or minus 3 dB, which was measured on the same condition of the embodiment 1 in the area of 16 mm square. The tilt angle of the polarizing axis is no more than 0.5 degrees, or plus or minus 0.25 degrees, shown in FIG. 4.

### Comparative Example 1

The glass base material of the embodiment 1 was treated with heat similarly to the embodiment 1 to be prepared the experimental glass preform in the same size of the embodiment 1. The glass preform was applied the stress by the taking-in means in approximately parallel to the longitudinal direction to be prepared an elongated glass. In the present comparative embodiment, the powers of the main heater 10, side heaters 20, and sub-heaters 12, 14, and 16 were controlled so that the glass preform shrunk with the outlines of the elongated part of the glass preform tilting by the tilted angle of about 24 degrees. The stress applied to the glass preform and the speeds of the transforming and taking-in the glass preform were the same as the embodiment 1.

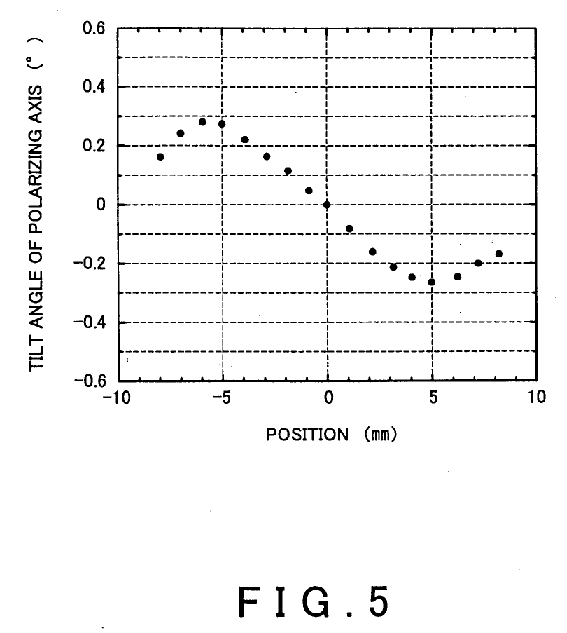

The width of the resulted elongated glass was 17 mm. The thicknesses of the middle part and the both sides were 0.4 mm and 0.485 mm respectively, and the variation of the thickness was no more than 0.03 mm. The extinction ratio of the elated glass reduced with hydrogen on the same condition of the embodiment 1 was 50 plus or minus 5 dB in the area of 16 mm square. The tilt angle was 0.6 degrees (plus or minus 0.30 degrees), shown in FIG. 5.

### Comparative Example 2

The glass base material the embodiment 1 was treated with heat to be prep experimental glass preform in the same size of the embodiment 1. The glass preform was applied the stress with the taking-in means approximately parallel to the longitudinal direction to make the elongated glass. In the present comparative embodiment, the powers of the main heater 10, side heaters 20, and sub-heaters 12, 14, and 16 were controlled so that the glass preform shrunk with the outlines of the elongated part of the glass preform tilting against the longitudinal direction by the tilt angle of about 32 degrees. The stress applied to the glass preform and the speeds of the feeding and the taking-in the glass preform were the same of the embodiment 1.

The width of the resulted elongated glass was 16.6 mm, and the cross section thereof was curved like the shape of S. The thickness of the center part was 0.446 mm and the thicknesses of the both sides were 0.489 mm and 0.491 mm respectively. The height between the top and the bottom of the cross section was approximately 0.6 mm. After the reducing process on the same condition of the embodiment 1, the extinction ratio and the polarizing axis were measured. The extinction ratio in the area of 14 mm square was 50 plus or minus 5 dB, and the tilt angle over the 14 mm width was 0.8 degrees, or plus or minus 0.40 degrees.

The above explanation shows apparently that according to the embodiment, in the elongating process the metal halide particles are elongated approximately evenly over the width of the glass base material to be oriented uniformly along the longitudinal direction of the glass base material. Therefore, the polarizing glass having the small variation of the in-plane extinction ratio and the uniformly oriented polarizing axis can be produced. The glass base material is elongated with a small difference in viscosity across the width of the elongated part, which allows producing the polarizing glass with small deviation from flatness after the elongating process.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A producing method of a polarizing glass which has elongated metal particles oriented in a uniform direction and dispersed therein comprises:
a preparing process to prepare a strip of glass base material containing metal halide particles precipitated therein;
an elongating process to elongate said glass base material and said metal halide particles while heating said glass base material with heaters put around said glass base material and drawing said glass base material to the longitudinal direction thereof with a drawing means set outside of said heaters along the longitudinal direction of said glass base material; and
a reducing process to reduce said metal halide particles included in the elongated glass and elongated in said elongating process,
wherein said elongating process, the powers of said heaters are controlled so that said glass base material shrinks with the outlines of said elongated part thereof tilting against the longitudinal direction thereof by from 5 degrees to 20 degrees.

2. The producing method of a polarizing glass according to claim 1, wherein said heaters may comprise a main heater which faces at said elongated part of the strip of said glass base material and heats near the center of the width of said elongated part and side heaters which heat the elongated part of the strip from the sides of the elongated part of the strip, wherein the powers of the heaters are controlled in the elongating process so that the temperature of the center of the width of the strip of the glass base material is equal to or lower than the temperature of the outer parts of the width.

3. The producing method of a polarizing glass according to claim 2, wherein the powers of said side heaters are bigger than the power of said main heater.

4. The producing method of a polarizing glass according to claim 1, wherein the powers of said heaters are controlled in said elongating process so that the temperature of said glass base material is equal to or more than the glass transition point temperature and equal to or less than the glass softening point temperature.

5. The producing method of a polarizing glass according to claim 1, wherein said drawing means applies the stress of no less than 200 kg/cm² and no more than 500 kg/cm² evenly across the width of said strip to draw said glass base material.

6. A polarizing glass including elongated metal particles oriented in a uniform direction and dispersed, which are produced by a method which comprises:
a preparing process to prepare a strip of glass base material containing metal halide particles precipitated therein;
an elongating process to elongate said glass base material and said metal halide particles while heating said glass base material with heaters put around said glass base material, and drawing said glass base material to the longitudinal direction thereof with a drawing means set outside of said heaters along the longitudinal direction of said glass base material; and
a reducing process to reduce said metal halide particles included in said elongated glass and elongated in said elongating process,
wherein the powers of said heaters are controlled in said elongating process, so that said glass base material shrinks with the outlines of said elongated part thereof tilting against the longitudinal direction thereof by from 5 degrees to 20 degrees,
wherein the variation of tilt angle of the polarizing axis of said elongated glass against the elongated direction of the elongated glass is 0.5 degrees or less.
